(19) United States
(12) Patent Application Publication
(10) Pub. No.: US 2017/0037297 A1
(43) Pub. Date: Feb. 9, 2017

(54) HYDROCARBON RECOVERY COMPOSITION, METHOD OF PREPARATION AND USE THEREOF

(71) Applicant: SHELL OIL COMPANY, Houston, TX (US)

(72) Inventors: Timothy Elton King, Houston, TX (US); Lori Ann CROM, Houston, TX (US); Julian Richard BARNES, Amsterdam (NL); Paulus Johannes KUNKELER, Rotterdam (NL)

(21) Appl. No.: 15/332,332

(22) Filed: Oct. 24, 2016

(51) Int. Cl. C09K 8/584; E21B 43/24; C09K 8/592

(52) U.S. Cl. CPC C09K 8/584; C09K 8/592; E21B 43/24

(57) ABSTRACT

The invention provides a hydrocarbon recovery composition comprising one or more internal olefin sulfonates and a pH buffer. The composition may be injected into a hydrocarbon-containing formation to enhance the recovery of hydrocarbons therefrom. The composition may also be used in a thermal enhanced oil recovery process that includes injecting a hot fluid with the hydrocarbon recovery composition to generate foam.

### FIELD OF THE INVENTION

The invention relates to a hydrocarbon recovery composition, a method of preparing the composition and a method of using the composition to recovery hydrocarbons from a formation. The composition comprises internal olefin sulfonates and a pH buffer.

### BACKGROUND

Hydrocarbons, including crude oil, may be recovered from underground formations through one or more wells. As more hydrocarbon is recovered from the well, it generally becomes more difficult to continue producing hydrocarbons. Supplemental oil recovery methods are then employed, including water flooding, gas flooding, thermal processes or combinations thereof. In recent years, there has been increased activity to develop chemical compounds that can be used as surfactants to mobilize the hydrocarbons by generating a sufficiently low crude oil/water interfacial tension.

Internal olefin sulfonates (IOS) are one of the types of surfactants that have been developed to assist in hydrocarbon recovery. These IOS compounds help reduce the interfacial tension and have been used in different types of formations. The compounds, however, may be subject to decomposition at elevated temperatures. It would be advantageous to develop a method for using the IOS compounds at elevated temperatures in a way that would prevent this decomposition.

### SUMMARY OF THE INVENTION

The invention provides a hydrocarbon recovery composition comprising one or more internal olefin sulfonates and a pH buffer.

The invention provides a method of recovering hydrocarbons from a formation comprising injecting a hydrocarbon recovery composition comprising one or more internal olefin sulfonates and a pH buffer.

The invention further provides a method of generating foam in a thermal enhanced oil recovery process comprising injecting a hot fluid, one or more internal olefin sulfonates and a pH buffer into a hydrocarbon formation.

### DETAILED DESCRIPTION

The invention provides an improved hydrocarbon recovery composition comprising the internal olefin sulfonates and a pH buffer. This composition is more resistant to decomposition of the internal olefin sulfonates when exposed to elevated temperatures.

### Manufacture of the Internal Olefin Sulfonate

U.S. Pat. Nos. 4,183,867 and 4,248,793, which are herein incorporated by reference, disclose processes which can be used to make the internal olefin sulfonates of the invention. In these processes, the internal olefins are contacted with a sulfonating agent, and the subsequent reaction product is subjected to a neutralization and hydrolysis step to prepare the internal olefin sulfonates.

One embodiment of a process which can be used to make internal olefin sulfonates for use in the present invention comprises reacting in a film reactor an internal olefin with a sulfonating agent in a mole ratio of sulfonating agent to internal olefin of from 1.02 to 1.3, preferably from 1:1 to 1.25:1 while cooling the reactor with a cooling means having a temperature in the range of from 30 to 60° C. In one embodiment, the cooling means has a temperature not exceeding 35° C. The reactor may be cooled by flowing a cooling means at the outside walls of the reactor. The sulfonating agent may be sulfur trioxide, sulfuric acid, or oleum. The film reactor is preferably a falling film reactor.

The sulfonation results in the formation of cyclic intermediates known as beta-sultones, which can undergo isomerization to unsaturated sulfonic acids and the more stable gamma- and delta-sultones. This process may be carried out batchwise, semi-continuously, or continuously. If sulfur trioxide is used as the sulfonating agent, it may be diluted with a stream of nitrogen, air, or any other inert gas. The concentration of sulfur trioxide is generally between 2 and 5 percent by volume based on the volume of the carrier gas.

The amount of unreacted internal olefins from the sulfonation reaction may be between 0.5 and 30 percent. The amount of unreacted internal olefins is preferably minimized during this step.

In a next step, sulfonated internal olefin from the sulfonation step is neutralized by contacting it with a base-containing solution. The base-containing solution is preferably a water soluble base, such as, sodium hydroxide or sodium carbonate. The corresponding bases derived from potassium or ammonium and amine bases, such as monoethanolamine, are also suitable. The neutralization of the reaction product from the falling film reactor is generally carried out with excessive base, calculated on the acid component. The neutralization may be carried out at a temperature in the range of from 0 to 80° C.

In this neutralization step, beta-sultones are converted into beta-hydroxyalkane sulfonates, whereas gamma- and delta-sultones are converted into gamma-hydroxyalkane sulfonates and delta-hydroxyalkane sulfonates, respectively. During this step, a portion of the hydroxyalkane sulfonates may be dehydrated into alkene sulfonates.

Next, the neutralized reaction product is subjected to a hydrolysis step. Hydrolysis may be carried out at a temperature in the range of from 100 to 250° C., preferably 130 to 200° C. The hydrolysis time generally may be from 5 minutes to 4 hours. Alkaline hydrolysis may be carried out with hydroxides, carbonates, bicarbonates of (earth) alkali metals, and amine compounds.

In the preparation of internal olefin sulfonates, it is required that in the neutralization and hydrolysis steps very intimate mixing of the reactor product and the aqueous base should be achieved. This can be done, for example, by efficient stirring or the addition of a polar cosolvent (such as a lower alcohol) or by the addition of a phase transfer agent. An example of the latter is an alcohol ethoxylate, such as NEODOL 91-8 and/or NEODOL 25-12.

### The Internal Olefin Sulfonate Composition

The sulfonating agent reacts with internal olefins at the position along the chain where the double bond is positioned. This results in a variety of twin-tailed products with varying lengths of the two tails. In addition, due to the many reactions involved during sulfonation, neutralization and hydrolysis the end product is a complex mixture. On average an IOS has a typical composition of 30-90% hydroxyalkane sulfonates, 15-55% alkene sulfonates and ca. 1-10% of disulfonate species. The actual composition of the end products is determined by the olefin feedstock type with the following structural features having an influence: carbon number distribution, linearity (including the amount and type of branched components) and molecular weight. The end product composition is also determined by process conditions, applied in particular in the sulfonation and neutralization steps. An internal olefin or IOS may be characterised by its carbon number, double bond distribution and/or linearity.

Branched IOS molecules are IOS molecules derived from internal olefin molecules which comprise one or more branches. Linear IOS molecules are IOS molecules derived from internal olefin molecules which are linear, that is to say which comprise no branches (unbranched internal olefin molecules). An internal olefin may be a mixture of linear internal olefin molecules and branched internal olefin molecules. Analogously, an IOS may be a mixture of linear IOS molecules and branched IOS molecules.

Reference to an average carbon number means that the internal olefin or IOS in question is a mixture of molecules which differ from each other in terms of carbon number. The average carbon number is determined by multiplying the number of carbon atoms of each molecule by the weight fraction of that molecule and then adding the products, resulting in a weight average carbon number. The average carbon number may be determined by gas chromatography (GC) analysis of the internal olefin.

The linearity is determined by dividing the weight of linear molecules by the total weight of branched, linear and cyclic molecules. Substituents (like the sulfonate group and optional hydroxy group in the internal olefin sulfonates) on the carbon chain are not seen as branches. The linearity may be determined by gas chromatography (GC) analysis of the internal olefin. Similarly, the branching is determined by this method and is expressed as % wt branching.

The “branching index” (BI) refers to the average number of branches per molecule, which may be determined by dividing the total number of branches by the total number of molecules. The branching index may be determined by 1H-NMR analysis.

When the branching index is determined by 1H-NMR analysis, the total number of branches equals: [total number of branches on olefinic carbon atoms (olefinic branches)]+[total number of branches on aliphatic carbon atoms (aliphatic branches)]. The total number of aliphatic branches equals the number of methine groups, which latter groups are of formula R3CH wherein R is an alkyl group. Further, said total number of olefinic branches equals: [number of trisubstituted double bonds]+[number of vinylidene double bonds]+2*[number of tetrasubstituted double bonds]. Formulas for said trisubstituted double bond, vinylidene double bond and tetrasubstituted double bond are shown below. In all of the below formulas, R is an alkyl group.

The average molecular weight is determined by multiplying the molecular weight of each surfactant molecule by the weight fraction of that molecule and then adding the products, resulting in a weight average molecular weight.

The internal olefin sulfonate composition comprises one or more internal olefin sulfonate compounds. The IOS is preferably at least 60 wt % linear, more preferably at least 70 wt %, more preferably at least 75 wt %, most preferably at least 80 wt % linear. For example, 60 to 100 wt %, more suitably 70 to 99 wt %, most suitably 80 to 99 wt % of the IOS may be linear. Branches in the IOS may include methyl, ethyl and/or higher molecular weight branches including propyl branches.

The IOS is preferably not substituted by groups other than sulfonate groups and optionally hydroxy groups. The IOS preferably has an average carbon number in the range of from 5 to 40, more preferably 10 to 32, even more preferably 12 to 30, and most preferably 15 to 28.

The IOS may preferably have a carbon number distribution within broad ranges. For example, in the present invention, the IOS may be selected from the group consisting of C₁₅₋₁₈ IOS, C₁₉₋₂₃ IOS, C₂₀₋₂₄ IOS, C₂₄₋₂₈ IOS and mixtures thereof. That is to say, the IOS may be C₁₅₋₁₈ IOS or C₁₉₋₂₃ IOS or C₂₀₋₂₄ IOS or C₂₄₋₂₈ IOS or any mixture thereof. IOS compounds suitable for use in the present invention include those from the ENORDET™ O series of surfactants commercially available from Shell Chemicals Company.

“Average carbon number” as used herein is determined by multiplying the number of carbon atoms of each internal olefin sulfonate in the mixture of internal olefin sulfonates by the mole percent of that internal olefin sulfonate and then adding the products.

“C₁₅₋₁₈ internal olefin sulfonate” as used herein means a mixture of internal olefin sulfonates wherein the mixture has an average carbon number of from about 16 to about 17 and at least 50% by weight, preferably at least 75% by weight, most preferably at least 90% by weight, of the internal olefin sulfonates in the mixture contain from 15 to 18 carbon atoms.

“C₁₉₋₂₃ internal olefin sulfonate” as used herein means a mixture of internal olefin sulfonates wherein the mixture has an average carbon number of from about 21 to about 23 and at least 50% by weight, preferably at least 60% by weight, of the internal olefin sulfonates in the mixture contain from 19 to 23 carbon atoms.

“C₂₀₋₂₄ internal olefin sulfonate” as used herein means a mixture of internal olefin sulfonates wherein the mixture has an average carbon number of from about 20.5 to about 23 and at least 50% by weight, preferably at least 65% by weight, most preferably at least 75% by weight, of the internal olefin sulfonates in the mixture contain from 20 to 24 carbon atoms.

“C₂₄₋₂₈ internal olefin sulfonate” as used herein means a blend of internal olefin sulfonates wherein the blend has an average carbon number of from 24.5 to 27 and at least 20% by weight, preferably at least 40% by weight, more preferably at least 50% by weight, most preferably at least 60% by weight, of the internal olefin sulfonates in the blend contain from 24 to 28 carbon atoms.

For the internal olefin sulfonates that are substituted by sulfonate groups, the cation may be any cation, such as an ammonium, amine, alkali metal or alkaline earth metal cation, preferably an ammonium or alkali metal cation.

In the present invention, the amount of alpha olefins in the internal olefin may be up to 5%, for example 1 to 4 wt % based on total composition. Further, in the present invention, the amount of paraffins in the internal olefin may be up to 10 wt %, for example up to 6 wt % based on total composition.

An IOS comprises a range of different molecules, which may differ from one another in terms of carbon number, being branched or unbranched, number of branches, molecular weight and number and distribution of functional groups such as sulfonate and hydroxyl groups. An IOS comprises both hydroxyalkane sulfonate molecules and alkene sulfonate molecules and possibly also di-sulfonate molecules. Di-sulfonate molecules originate from a further sulfonation of for example an alkene sulfonic acid.

The IOS may comprise at least 25% hydroxyalkane sulfonate molecules, up to 70% alkene sulfonate molecules and up to 15% di-sulfonate molecules. In one embodiment, the IOS comprises from 25% to 60% hydroxyalkane sulfonate molecules, from 30% to 60% alkene sulfonate molecules and from 0% to 15% di-sulfonate molecules. In another embodiment, the IOS comprises from 50% to 90% hydroxyalkane sulfonate molecules, from 10% to 40% alkene sulfonate molecules and from less than 1% to 5% di-sulfonate molecules. In a further embodiment, the IOS comprises from 35% to 70% hydroxyalkane sulfonate molecules, from 20% to 60% alkene sulfonate molecules and from less than 1% to 10% di-sulfonate molecules. The composition of the IOS may be measured using a mass spectrometry (MS) technique.

### The Hydrocarbon Recovery Composition

In an embodiment, a hydrocarbon recovery composition may be provided to the hydrocarbon-bearing formation. In this invention the composition comprises a particular internal olefin sulfonate or blend of internal olefin sulfonates. Internal olefin sulfonates are chemically suitable for EOR because they have a low tendency to form ordered structures/liquid crystals (which can be a major issue because ordered structures tend to lead to plugging of the rock structure in hydrocarbon formations, and possible emulsion formation) because they are a complex mixture of surfactants with different chain lengths. Internal olefin sulfonates show a low tendency to adsorb on reservoir rock surfaces arising from negative-negative charge repulsion between the surface and the surfactant. The use of alkali further reduces the tendency for surfactants to adsorb and reduced losses means a lower concentration of the surfactant can be used making the process more economic. However, this may also lead to emulsion stabilization due to the presence of natural surfactants present in the crude oil (e.g., naphthenic acids). Therefore, selection of crude oils for this chemical EOR method must be done with caution. Moreover, injection of alkali may lead to formation damage in particular mineralogy.

This invention is particularly useful in hydrocarbon-bearing formations which contain crude oil with higher salinity brine. The hydrocarbon recovery composition of this invention is designed to produce the best internal olefin sulfonate recovery composition for these hydrocarbon-bearing formations and for the brine found in these formations. This material is effective over a salinity range of about 1% by weight or lower to about 10% by weight or higher and over a temperature range of from about 40 to 140° C.

In an embodiment, the hydrocarbon recovery composition may comprise from about 1 to about 90 wt % of the internal olefin sulfonate or blend containing it. In certain embodiments, the hydrocarbon recovery composition may comprise preferably from about 10 to about 40 wt % and more preferably from about 20 to about 30 wt %. In certain embodiments, the hydrocarbon recovery composition preferably comprises from 50 to 80 wt % of the internal olefin sulfonate. In an embodiment, a hydrocarbon containing composition may be produced from a hydrocarbon-bearing formation. The hydrocarbon-bearing composition may include any combination of hydrocarbons, the internal olefin sulfonate described above, a solubilizing agent, gas, water, crude oil solubility groups (e.g., asphaltenes, resins), specific chemical families (e.g., naphthenic acids, basic nitrogen compounds).

In addition to the IOS, the hydrocarbon recovery composition comprises one or more compounds that function as a pH buffer. A pH buffer is an aqueous solution comprising a weak acid and its conjugate base or a weak base and its conjugate acid. The pH of the buffer changes very little when a small amount of a strong acid or base is added to the buffer. pH buffer solutions can be used to keep the pH at a substantially constant value in the hydrocarbon recovery composition.

The pH buffer may comprise a base selected from the group consisting of ammonia, trimethyl ammonia, pyridine and other amine containing compounds and ammonium hydroxide. The pH buffer may comprise an inorganic base. Preferred embodiments of inorganic bases are the conjugate bases of boric acid and phosphoric acid.

The pH buffer may comprise an acid selected from the group consisting of formic acid, acetic acid, propanoic acid, butanoic acid, pentanoic acid, hexanoic acid, heptanoic acid, octanoic acid, nonanoic acid, decanoic acid, trichloroacetic acid, hydrofluoric acid, hydrocyanic acid, phosphoric acid, oxalic acid, nitrous acid, benzoic acid, ascorbic acid, boric acid, chromic acid, citric acid, carbonic acid, lactic acid, sulfurous acid, uric acid. The pH buffer may comprise KH₂PO₄, Na₂HPO₄ or mixtures thereof.

The remainder of the composition may include, but is not limited to, water, low molecular weight alcohols, organic solvents, alkyl sulfonates, aryl sulfonates, brine or combinations thereof. Low molecular weight alcohols include, but are not limited to, methanol, ethanol, propanol, isopropyl alcohol, tert-butyl alcohol, sec-butyl alcohol, butyl alcohol, tert-amyl alcohol or combinations thereof. Organic solvents include, but are not limited to, methyl ethyl ketone, acetone, lower alkyl cellosolves, lower alkyl carbitols or combinations thereof.

A “formation” includes one or more hydrocarbon containing layers, one or more non-hydrocarbon layers, an overburden and/or an underburden. An “overburden” and/or an “underburden” includes one or more different types of impermeable materials. For example, overburden/underburden may include rock, shale, mudstone, or wet/tight carbonate (i.e., an impermeable carbonate without hydrocarbons). For example, an underburden may contain shale or mudstone. In some cases, the overburden/underburden may be somewhat permeable. For example, an underburden may be composed of a permeable mineral such as sandstone or limestone. In some embodiments, at least a portion of a hydrocarbon-bearing formation may exist at less than or more than 1000 feet below the earth's surface.

The properties of a hydrocarbon-bearing formation may affect how hydrocarbons flow through an underburden/overburden to one or more production wells. The properties of interest include, but are not limited to, mineralogy, porosity, permeability, pore size distribution, surface area, salinity and temperature of the formation. Overburden/underburden properties in combination with hydrocarbon properties, such as, capillary pressure (static) characteristics and relative permeability (flow) characteristics may affect the mobilization of hydrocarbons through the hydrocarbon containing formation.

The permeability of a hydrocarbon-bearing formation may vary depending on the formation composition. A relatively permeable formation may include heavy hydrocarbons entrained in, for example, sand or carbonate. “Relatively permeable,” as used herein, refers to formations or portions thereof, that have an average permeability of 10 millidarcy or more. “Relatively low permeability” as used herein, refers to formations or portions thereof that have an average permeability of less than about 10 millidarcy. One darcy is equal to about 0.99 square micrometers. An impermeable portion of a formation generally has a permeability of less than about 0.1 millidarcy. In some cases, a portion or all of a hydrocarbon of a relatively permeable formation may include predominantly heavy hydrocarbons and/or tar with no supporting mineral grain framework and only floating (or no) mineral matter (e.g., asphalt lakes).

Fluids (e.g., gas, water, hydrocarbons or combinations thereof) of different densities may exist in a hydrocarbon-bearing formation. A mixture of fluids in the hydrocarbon-bearing formation may form layers between an underburden and an overburden according to fluid density. Gas may form a top layer, hydrocarbons may form a middle layer and water may form a bottom layer in the hydrocarbon-bearing formation. The fluids may be present in the hydrocarbon-bearing formation in various amounts. Interactions between the fluids in the formation may create interfaces or boundaries between the fluids. Interfaces or boundaries between the fluids and the formation may be created through interactions between the fluids and the formation. Typically, gases do not form boundaries with other fluids in a hydrocarbon containing formation. In an embodiment, a first boundary may form between a water layer and underburden. A second boundary may form between a water layer and a hydrocarbon layer. A third boundary may form between hydrocarbons of different densities in a hydrocarbon-bearing formation. Multiple fluids with multiple boundaries may be present in a hydrocarbon-bearing formation, in some embodiments. It should be understood that many combinations of boundaries between fluids and between fluids and the overburden/underburden may be present in a hydrocarbon-bearing formation.

The production of fluids may perturb the interaction between fluids and between fluids and the overburden/underburden. As fluids are removed from the hydrocarbon containing formation, the different fluid layers may mix and form mixed fluid layers. The mixed fluids may have different interactions at the fluid boundaries. Depending on the interactions at the boundaries of the mixed fluids, production of hydrocarbons may become difficult. Quantification of the interactions (e.g., energy level) at the interface of the fluids and/or fluids and overburden/underburden may be useful to predict mobilization of hydrocarbons through the hydrocarbon-bearing formation.

Quantification of the energy required for interactions (e.g., mixing) between fluids within a formation at an interface may be difficult to measure. Quantification of energy levels at an interface between fluids may be determined by generally known techniques (e.g., spinning drop tensionmeter, Langmuir trough). Interaction energy requirements at an interface may be referred to as interfacial tension. “Interfacial tension” as used herein, refers to a surface free energy that exists between two or more fluids that exhibit a boundary. A high interfacial tension value (e.g., greater than about 10 dynes/cm) may indicate the inability of one fluid to mix with a second fluid to form a fluid emulsion. As used herein, an “emulsion” refers to a dispersion of one immiscible fluid into a second fluid by addition of a composition that reduces the interfacial tension between the fluids to achieve some degree of stability. The inability of the fluids to mix may be due to high surface interaction energy between the two fluids or due to the presence of solubility groups or specific chemical families. Low interfacial tension values (e.g., less than about 1 dyne/cm) may indicate less surface interaction between the two immiscible fluids. Less surface interaction energy between two immiscible fluids may result in the mixing of the two fluids to form an emulsion. Fluids with low interfacial tension values may be mobilized to a well bore due to reduced capillary forces and subsequently produced from a hydrocarbon-bearing formation. Interfacial tension is also a function of aqueous properties such as pH and cation content.

The fluids in a hydrocarbon-bearing formation may wet (e.g., adhere to an overburden/underburden or spread onto an overburden/underburden in a hydrocarbon containing formation). As used herein, “wettability” refers to the preference of a fluid to spread on or adhere to a solid surface in a formation in the presence of other fluids. In an embodiment, hydrocarbons may adhere to sandstone in the presence of gas or water. An overburden/underburden that is substantially coated by hydrocarbons may be referred to as “oil wet.” An overburden/underburden may be oil wet due to the presence of polar and/or or surface-active components (e.g., asphaltenes) in the hydrocarbon-bearing formation. Formation composition (e.g., silica, carbonate or clay) may determine the amount of adsorption of hydrocarbons on the surface of an overburden/underburden. In some embodiments, a porous and/or permeable formation may allow hydrocarbons to more easily wet the overburden/underburden. A substantially oil wet overburden/underburden may inhibit hydrocarbon production from the hydrocarbon-bearing formation. In certain embodiments, an oil wet portion of a hydrocarbon-bearing formation may be located at less than or more than 1000 feet below the earth's surface.

A hydrocarbon formation may include water. Water may interact with the surface of the underburden. As used herein, “water wet” refers to the formation of a coat of water on the surface of the overburden/underburden. A water wet overburden/underburden may enhance hydrocarbon production from the formation by preventing hydrocarbons from wetting the overburden/underburden. In certain embodiments, a water wet portion of a hydrocarbon-bearing formation may include minor amounts of polar and/or or surface-active components.

Water in a hydrocarbon-bearing formation may contain minerals (e.g., minerals containing barium, calcium, or magnesium) and mineral salts (e.g., sodium chloride, potassium chloride, magnesium chloride). Water salinity, cation content, pH and/or water hardness in a formation may affect recovery of hydrocarbons in a hydrocarbon-bearing formation. As used herein “salinity” refers to an amount of dissolved solids in water. “Water hardness,” as used herein, refers to a concentration of divalent ions (e.g., calcium, magnesium) in the water. Water salinity and hardness may be determined by generally known methods (e.g., conductivity, titration). As water salinity increases in a hydrocarbon-bearing formation, interfacial tensions between hydrocarbons and water may be increased and the fluids may become more difficult to produce. The interfacial tension is also a strong function of the dominant cation present in the water phase, pH and temperature.

A hydrocarbon-bearing formation may be selected for treatment based on factors such as, but not limited to, thickness of hydrocarbon containing layers within the formation, assessed liquid production content, location of the formation, salinity content of the formation, temperature of the formation, mineralogy and depth of hydrocarbon-bearing layers. Initially, natural formation pressure and temperature may be sufficient to cause hydrocarbons to flow into well bores and out to the surface. Temperatures in a hydrocarbon containing formation may range from about 0° C. to about 300° C. The composition of the present invention can be advantageous when used at high temperature because the internal olefin sulfonate is stable at such temperatures. As hydrocarbons are produced from a hydrocarbon-bearing formation, pressures and/or temperatures within the formation may decline. Various forms of artificial lift (e.g., pumps, gas injection) and/or heating may be employed to continue to produce hydrocarbons from the hydrocarbon-bearing formation. Production of desired hydrocarbons from the hydrocarbon-bearing formation may become uneconomical as hydrocarbons are depleted from the formation.

Mobilization of residual hydrocarbons retained in a hydrocarbon-bearing formation may be difficult due to the viscosity of the hydrocarbons and capillary effects of fluids in pores of the hydrocarbon-bearing formation. As used herein “capillary forces” refers to attractive forces between fluids and at least a portion of the hydrocarbon-bearing containing formation. In an embodiment, capillary forces may be overcome by increasing the pressures within a hydrocarbon-bearing formation. In other embodiments, capillary forces may be overcome by reducing the interfacial tension between fluids in a hydrocarbon-bearing formation. The ability to reduce the capillary forces in a hydrocarbon-bearing formation may depend on a number of factors, including, but not limited to, the temperature of the hydrocarbon-bearing formation, the salinity and cationic composition of water in the hydrocarbon-bearing formation, and the precise composition of the hydrocarbon-bearing formation.

As production rates decrease, additional methods may be employed to make a hydrocarbon-bearing formation more economically viable. Methods may include adding sources of water (e.g., brine, steam), gases (e.g., carbon dioxide, nitrogen), alkaline fluids, polymers, monomers or any combinations thereof to the hydrocarbon formation to increase mobilization of hydrocarbons.

In an embodiment, a hydrocarbon-bearing formation may be treated with a flood of water. A waterflood may include injecting water into a portion of a hydrocarbon-bearing formation through injections wells. Flooding of at least a portion of the formation may water wet a portion of the hydrocarbon-bearing formation. The water wet portion of the hydrocarbon-bearing formation may be pressurized by known methods and a water/hydrocarbon mixture may be collected using one or more production wells. The water layer, however, may not mix with the hydrocarbon layer efficiently. Poor mixing efficiency may be due to a high interfacial tension between the water and hydrocarbons.

Production from a hydrocarbon-bearing formation may be enhanced by treating the hydrocarbon-bearing formation with a polymer and/or monomer that may mobilize hydrocarbons to one or more production wells. The polymer and/or monomer may reduce the mobility of the water phase in pores of the hydrocarbon-bearing formation. The reduction of water mobility may allow the hydrocarbons to be more easily mobilized through the hydrocarbon-bearing formation. Polymers include, but are not limited to, polyacrylamides, partially hydrolyzed polyacrylamide, polyacrylates, ethylenic copolymers, biopolymers, carboxymethylcellulose, polyvinyl alcohol, polystyrene sulfonates, polyvinylpyrrolidone, AMPS (2-acrylamide-2-methyl propane sulfonate) or combinations and or modifications thereof. Examples of ethylenic copolymers include copolymers of acrylic acid and acrylamide, acrylic acid and lauryl acrylate, lauryl acrylate and acrylamide. Examples of biopolymers include xanthan gum and guar gum. In some embodiments, polymers may be cross linked in situ in a hydrocarbon-bearing formation. In other embodiments, polymers may be generated in situ in a hydrocarbon-bearing formation.

### Injection of the Hydrocarbon Recovery Composition

In an embodiment, the hydrocarbon recovery composition is provided to the hydrocarbon-bearing formation by admixing it with water and/or brine from the formation. Preferably, the hydrocarbon recovery composition comprises from about 0.01 to about 2.0 wt % of the total water and/or brine/hydrocarbon recovery composition mixture (the injectable fluid). More important is the amount of actual active matter that is present in the injectable fluid (active matter is the surfactant, here the internal olefin sulfonate or blend containing it). Thus, the amount of the internal olefin sulfonate in the injectable fluid may be from about 0.05 to about 1.0 wt %, preferably from about 0.1 to about 0.8 wt %. The injectable fluid is then injected into the hydrocarbon-bearing formation.

In an embodiment, a hydrocarbon composition may be produced from a hydrocarbon containing formation. The hydrocarbon containing the composition may include any combination of hydrocarbons, internal olefin sulfonate, associated gas, water, solubility groups (asphaltenes, resins, saturates, aromatics), or specific chemical families (naphthenic acids, basic nitrogen compounds).

The hydrocarbon recovery composition may interact with hydrocarbons in at least a portion of the hydrocarbon containing formation. Interaction with the hydrocarbons may reduce an interfacial tension of the hydrocarbons with one or more fluids in the hydrocarbon-bearing formation. In other embodiments, a hydrocarbon recovery composition may reduce the interfacial tension between the hydrocarbons and an overburden/underburden of a hydrocarbon-bearing formation. Reduction of the interfacial tension may allow at least a portion of the hydrocarbons to mobilize through the hydrocarbon-bearing formation.

The ability of a hydrocarbon recovery composition to reduce the interfacial tension of a mixture of hydrocarbons and fluids may be evaluated using known techniques. In an embodiment, an interfacial tension value for a mixture of hydrocarbons and water may be determined using a spinning drop tensionmeter. This is carried out under controlled laboratory conditions, so it is only an approximation of reservoir conditions. An amount of the hydrocarbon recovery composition may be added to the hydrocarbon/water mixture and an interfacial tension value for the resulting fluid may be determined. A low interfacial tension value (e.g., less than about 1 dyne/cm) may indicate that the composition reduced at least a portion of the surface energy between the hydrocarbons and water. Reduction of surface energy may indicate that at least a portion of the hydrocarbon/water mixture may mobilize through at least a portion of a hydrocarbon-bearing formation.

In an embodiment, a hydrocarbon recovery composition may be added to a hydrocarbon/water mixture and the interfacial tension value may be determined. Preferably, the interfacial tension is less than about 0.1 dyne/cm. An ultralow interfacial tension value (e.g., less than about 0.01 dyne/cm) may indicate that the hydrocarbon recovery composition lowered at least a portion of the surface tension between the hydrocarbons and water such that at least a portion of the hydrocarbons may mobilize through at least a portion of the hydrocarbon-bearing formation. At least a portion of the hydrocarbons may mobilize more easily through at least a portion of the hydrocarbon-bearing formation at an ultra-low interfacial tension than hydrocarbons that have been treated with a composition that results in an interfacial tension value greater than 0.01 dynes/cm for the fluids in the formation. Addition of a hydrocarbon recovery composition to fluids in a hydrocarbon-bearing formation that results in an ultra-low interfacial tension value may increase the efficiency at which hydrocarbons may be produced. A hydrocarbon recovery composition concentration in the hydrocarbon containing formation may be minimized to minimize cost of use during production.

A hydrocarbon recovery composition may be provided to the formation in an amount based on hydrocarbons present in a hydrocarbon-bearing formation. The amount of hydrocarbon recovery composition, however, may be too small to be accurately delivered to the hydrocarbon-bearing formation using known delivery techniques (e.g., pumps). To facilitate delivery of small amounts of the hydrocarbon recovery composition to the hydrocarbon-bearing formation, the hydrocarbon recovery composition may be combined with water and/or brine to produce an injectable fluid.

In an embodiment, the hydrocarbon recovery composition is provided to the formation containing crude oil with heavy components by admixing it with brine from the formation from which hydrocarbons are to be extracted or with fresh water. The mixture is then injected into the hydrocarbon-bearing formation.

In an embodiment, the hydrocarbon recovery composition is provided to a hydrocarbon-bearing formation by admixing it with brine from the formation. Preferably, the hydrocarbon recovery composition comprises from about 0.01 to about 2.00 wt % of the total water and/or brine/hydrocarbon recovery composition mixture (the injectable fluid). More important is the amount of actual active matter that is present in the injectable fluid (active matter is the surfactant, here the internal olefin sulfonate or the blend containing it). Thus, the amount of the internal olefin sulfonate in the injectable fluid may be from about 0.05 to about 1.0 wt %, preferably from about 0.1 to about 0.8 wt %. More than 1.0 wt % could be used but this would likely increase the cost without enhancing the performance. The injectable fluid is then injected into the hydrocarbon-bearing formation.

C₁₅₋₁₈ internal olefin sulfonates, C₁₉₋₂₃ internal olefin sulfonates, C₂₀₋₂₄ internal olefin sulfonates, C₂₄₋₂₈ internal olefin sulfonates and mixtures thereof may be blended together to enhance the properties of the surfactant mixture.

The internal olefin sulfonate may be used without a co-surfactant and/or a solvent. The internal olefin sulfonate may not perform optimally by itself for certain crude oils. This is a result of the overall crude oil composition. Co-surfactants and/or co-solvents may be added to the hydrocarbon recovery composition to enhance the activity.

The hydrocarbon recovery composition may interact with at least a portion of the hydrocarbons in hydrocarbon layer. The interaction of the hydrocarbon recovery composition with hydrocarbon layer may reduce at least a portion of the interfacial tension between different hydrocarbons. The hydrocarbon recovery composition may also reduce at least a portion of the interfacial tension between one or more fluids (e.g., water, hydrocarbons) in the formation and the under burden, one or more fluids in the formation and the overburden or combinations thereof.

In an embodiment, a hydrocarbon recovery composition may interact with at least a portion of hydrocarbons and at least a portion of one or more other fluids in the formation to reduce at least a portion of the interfacial tension between the hydrocarbons and one or more fluids. Reduction of the interfacial tension may allow at least a portion of the hydrocarbons to form an emulsion with at least a portion of one or more fluids in the formation. An interfacial tension value between the hydrocarbons and one or more fluids may be altered by the hydrocarbon recovery composition to a value of less than about 0.1 dyne/cm. In some embodiments, an interfacial tension value between the hydrocarbons and other fluids in a formation may be reduced by the hydrocarbon recovery composition to be less than about 0.05 dyne/cm. An interfacial tension value between hydrocarbons and other fluids in a formation may be lowered by the hydrocarbon recovery composition to less than 0.001 dyne/cm, in other embodiments.

At least a portion of the hydrocarbon recovery composition/hydrocarbon/fluids mixture may be mobilized to a production well. Products obtained from the production well may include, but are not limited to, components of the hydrocarbon recovery composition (e.g., a long chain aliphatic alcohol and/or a long chain aliphatic acid salt), gas, water, hydrocarbons, solubility groups (e.g., asphaltenes, resins) and/or chemical families (naphthenic acids, basic nitrogen), or combinations thereof. Hydrocarbon production from the hydrocarbon-bearing formation may be increased by greater than about 50% after the hydrocarbon recovery composition has been added to a hydrocarbon-bearing formation.

In certain embodiments, the hydrocarbon-bearing formation may be pretreated with a hydrocarbon removal fluid. A hydrocarbon removal fluid may be composed of water, steam, brine, gas, liquid polymers, foam polymers, monomers or mixtures thereof. A hydrocarbon removal fluid may be used to treat a formation before a hydrocarbon recovery composition is provided to the formation. The hydrocarbon-bearing formation may be less than 1000 feet below the earth's surface, in some embodiments. A hydrocarbon removal fluid may be heated before injection into a hydrocarbon-bearing formation, in certain embodiments. The hydrocarbon removal fluid may be heated to a temperature greater than 140° C. In another embodiment, the hydrocarbon removal fluid may be heated to a temperature greater than 200° C. A hydrocarbon removal fluid may reduce a viscosity of at least a portion of the hydrocarbons within the formation. Reduction of the viscosity of at least a portion of the hydrocarbons in the formation may enhance mobilization of at least a portion of the hydrocarbons to the production well. After at least a portion of the hydrocarbons in the hydrocarbon-bearing formation have been mobilized, repeated injection of the same or different hydrocarbon removal fluids may become less effective in mobilizing hydrocarbons through the hydrocarbon-bearing formation. Low efficiency of mobilization may be due to hydrocarbon removal fluids creating more permeable zones in the hydrocarbon-bearing formation. Hydrocarbon removal fluids may pass through the permeable zones in the hydrocarbon-bearing formation and not interact with and mobilize the remaining hydrocarbons. Consequently, displacement of heavier hydrocarbons adsorbed to the underburden may be reduced over time. Eventually, the formation may be considered low producing or economically undesirable to produce hydrocarbons.

In certain embodiments, injection of a hydrocarbon recovery composition after treating the hydrocarbon containing formation with a hydrocarbon removal fluid may enhance mobilization of heavier hydrocarbons absorbed to the underburden. The hydrocarbon recovery composition may interact with the hydrocarbons to reduce an interfacial tension between the hydrocarbons and the underburden. Reduction of the interfacial tension may be such that hydrocarbons are mobilized to and produced from the production well. Produced hydrocarbons from the production well may include, in some embodiments, at least a portion of the components of the hydrocarbon recovery composition, the hydrocarbon removal fluid injected into the well for pretreatment, methane, carbon dioxide, ammonia, or combinations thereof. Adding the hydrocarbon recovery composition to at least a portion of a low producing hydrocarbon-bearing formation may extend the production life of the hydrocarbon-bearing formation. Hydrocarbon production from a hydrocarbon-bearing formation may be increased by greater than about 50% after the hydrocarbon recovery composition has been added to the hydrocarbon-bearing formation. Increased hydrocarbon production may increase the economic viability of the hydrocarbon-bearing formation.

Interaction of the hydrocarbon recovery composition with at least a portion of hydrocarbons in the formation may reduce at least a portion of an interfacial tension between the hydrocarbons and the underburden. Reduction of at least a portion of the interfacial tension may mobilize at least a portion of hydrocarbons through the hydrocarbon-bearing formation. Mobilization of at least a portion of hydrocarbons, however, may not be at an economically viable rate.

In one embodiment, polymers and/or monomers may be injected into the hydrocarbon formation through an injection well, after treatment of the formation with a hydrocarbon recovery composition, to increase mobilization of at least a portion of the hydrocarbons through the formation. Suitable polymers include, but are not limited to, FLOPAM™ (hydrolyzed poly acrylamide polymers), manufactured by SNF, CIBA® ALCOFLOOD®, manufactured by Ciba Specialty Additives (Tarrytown, N.Y.), Tramfloc® manufactured by Tramfloc Inc. (Temple, Ariz.), and HE® polymers manufactured by Chevron Phillips Chemical Co. (The Woodlands, Tex.). Interaction between the hydrocarbons, the hydrocarbon recovery composition and the polymer may increase mobilization of at least a portion of the hydrocarbons remaining in the formation to production well.

The internal olefin sulfonate of the composition is thermally stable and may be used over a wide range of temperatures. The hydrocarbon recovery composition may be added to a portion of a hydrocarbon-bearing formation that has an average temperature of above about 140° C. or even above 200° C. because of the high thermal stability of the internal olefin sulfonate when combined with a pH buffer.

In some embodiments, a hydrocarbon recovery composition may be combined with at least a portion of a hydrocarbon removal fluid (e.g. water, polymer solutions) to produce an injectable fluid. The hydrocarbon recovery composition may be injected into a hydrocarbon-bearing formation through an injection well. Interaction of the hydrocarbon recovery composition with hydrocarbons in the formation may reduce at least a portion of an interfacial tension between the hydrocarbons and the underburden. Reduction of at least a portion of the interfacial tension may mobilize at least a portion of hydrocarbons to a section in hydrocarbon-bearing formation to form a hydrocarbon pool. At least a portion of the hydrocarbons may be produced from the hydrocarbon pool in the section of hydrocarbon-bearing formation.

In other embodiments, mobilization of at least a portion of hydrocarbons to a selected section may not be at an economically viable rate. Polymers may be injected into the hydrocarbon formation to increase mobilization of at least a portion of the hydrocarbons through the formation. Interaction between at least a portion of the hydrocarbons, the hydrocarbon recovery composition and the polymers may increase mobilization of at least a portion of the hydrocarbons to the production well.

In another embodiment, the hydrocarbon recovery composition containing surfactant may be combined with and/or injected at the same time as a hot fluid. The hot fluid may be steam, nitrogen, another inert gas or a hydrocarbon. In one embodiment, the hot fluid may be a hydrocarbon that is produced from the formation. The hot fluid reduces the viscosity of the crude oil making it easier to flow through the reservoir and/or be subjected to gravity drainage so that it can be produced from a well. The injection of the hydrocarbon recovery composition at the same time as a hot fluid, e.g., steam, produces a foam that reduces the mobility of the hydrocarbon recovery composition through the formation. Due to the reduction in mobility, these foams provide a substantial improvement in oil-displacing efficiency over the use of steam by itself. As the temperature is high for this injection process, the temperature stability of the hydrocarbon recovery composition and the surfactant is an important consideration.

In some embodiments, a hydrocarbon recovery composition may include an inorganic salt (e.g. sodium carbonate (Na₂CO₃), sodium hydroxide, sodium chloride (NaCl), or calcium chloride (CaCl₂)). The addition of the inorganic salt may help the hydrocarbon recovery composition disperse throughout a hydrocarbon/water mixture. The enhanced dispersion of the hydrocarbon recovery composition may decrease the interactions between the hydrocarbon and water interface. Addition of different salts will affect the final IFT of the system. The use of an alkali (e.g., sodium carbonate, sodium hydroxide) may prevent adsorption of the IOS onto the rock surface and may create natural surfactants with components in the crude oil. The decreased interaction may lower the interfacial tension of the mixture and provide a fluid that is more mobile. The alkali may be added in an amount of from about 0.1 to 2.0 wt %.

Under the temperature and pressure conditions in the reservoir, the internal olefin sulfonate is soluble and is effective in lowering the IFT. However, conditions above ground where the injectable fluid composition is prepared are different, i.e., lower temperature and pressure. Under such conditions and in a low salinity brine or freshwater (no salinity), the internal olefin sulfonate may not be completely soluble. Before the injectable fluid can be injected, at least a significant portion of the internal olefin sulfonate may fall out of the mixture. Any portion of the surfactant that is not in solution, i.e. that remains insoluble and forms a waxy precipitate, will eventually plug the porous formation around the wellbore. The result will be that the injection well will plug, with the consequent loss of the ability to inject the fluid. Remedial treatments will have to be done to the well to put it back in function with the consequent loss of time and expense.

In one embodiment, the hydrocarbon recovery composition is heated before it is injected into the formation. The hydrocarbon recovery composition may be a heated to a temperature up to or greater than 140° C.

### EXAMPLES

A number of C₁₅₋₁₈ IOS samples were tested to determine their stability under high temperature conditions. A lower carbon number internal olefin sulfonate, such as C₁₅₋₁₈ IOS, has good foaming properties which make it suitable as a co-injectant with a hot fluid, such as steam, to generate foam in a reservoir.

The samples were prepared such that each had 2% active matter (C₁₅₋₁₈ IOS), and deionized water. Comparative Example 1 did not contain a pH buffer, but the other Examples did contain a pH buffer as described below. The examples with a pH buffer all had an initial pH of about 7. In order to imitate a steam foam enhanced oil recovery application, the samples were heated in an autoclave to 240° C. and held at that temperature for a period of 100 hours. Nitrogen was used to purge the autoclave headspace to reduce exposure of the sample to oxygen. The samples were actively mixed to ensure a uniform temperature distribution.

Samples were removed from the autoclave at different times to measure the pH and active matter content, and the results are shown in the following tables. The pH measurements were carried out at approximately 20° C. using a pH probe and the active matter content was determined by potentiometric titration. For the active matter content, the test was performed twice and the average was reported. The active matter was reported as a normalized active matter which was calculated by dividing the active matter at a given time by the active matter present in the initial sample.

### Comparative Example 1

In this example, the sample comprised C₁₅₋₁₈ IOS (2% active matter), and deionized water (no pH buffer was added). The measurements are reported in Table 1.

TABLE 1

| Time (hours) | pH | Normalized active matter |
|---|---|---|
| 0 | 10.5 | 1.00 |
| 20 | 7.5 | 1.03 |
| 45 | 6 | 1.01 |
| 100 | 2 | 0.34 |

As can be seen from the table, the pH dropped to 6 after 45 hours, but the active matter content did not change. However, at 100 hours, a significant reduction in both pH and active matter content was observed. A non-buffered C₁₅₋₁₈ IOS would likely not be suitable for application in a field at an elevated temperature.

### Example 2

In this example, the sample comprised C₁₅₋₁₈ IOS (2% active matter), 0.35 wt % KH₂PO₄, 0.35 wt % Na₂HPO₄ and the balance was deionized water. The measurements are reported in Table 2.

TABLE 2

| Time (hours) | pH | Normalized active matter |
|---|---|---|
| 0 | 7.0 | 1.00 |
| 3 | 6.9 | 1.00 |
| 24 | 6.9 | 1.01 |
| 48 | 6.9 | 1.00 |
| 72 | 6.8 | 1.00 |
| 100 | 6.7 | 1.02 |

As can be seen from this Example, there was no decrease in the active matter concentration of the sample with only a small change in the pH.

### Example 3

In this example, the sample comprised C₁₅₋₁₈ IOS (2% active matter), 0.175 wt % KH₂PO₄, 0.175 wt % Na₂HPO₄ and the balance was deionized water. The measurements are reported in Table 3.

TABLE 3

| Time (hours) | pH | Normalized active matter |
|---|---|---|
| 0 | 7.1 | 1.00 |
| 24 | 6.4 | 0.96 |
| 48 | 6.3 | 0.95 |
| 72 | 6.2 | 0.95 |
| 100 | 6.1 | 0.97 |

As can be seen from this Example, there was only a slight decrease in the active matter concentration of the sample.

### Example 4

In this example, the sample comprised C₁₅₋₁₈ IOS (2% active matter), 0.10 wt % KH₂PO₄, 0.10 wt % Na₂HPO₄ and the balance was deionized water. The measurements are reported in Table 4.

TABLE 4

| Time (hours) | pH | Normalized active matter |
|---|---|---|
| 0 | 7.3 | 1.00 |
| 24 | 6.8 | 0.96 |
| 48 | 6.8 | 0.98 |
| 72 | 6.7 | 0.96 |
| 100 | 6.4 | 0.95 |

As can be seen from this Example, there was only a slight decrease in the active matter concentration of the sample. Further, as can be seen from Examples 2-4, the pH buffered samples maintained the active matter concentration throughout the test, and these types of pH buffered IOS solutions would be more suitable for application in a field at an elevated temperature, including for co-injection with a hot fluid, such as steam.

1. A hydrocarbon recovery composition comprising one or more internal olefin sulfonates and a pH buffer.

2. The composition of claim 1 wherein the pH buffer comprises a weak acid and its conjugate base; or a weak base and its conjugate acid.

3. The composition of claim 1 wherein the pH buffer comprises a base selected from the group consisting of ammonia, trimethyl ammonia, pyridine and other amine containing compounds, ammonium hydroxide.

4. The composition of claim 1 wherein the pH buffer comprises an inorganic base.

5. The composition of claim 4 wherein the base is the conjugate base of boric acid or phosphoric acid.

6. The composition of claim 3 wherein the pH buffer comprises the conjugate acid of one or more of the bases.

7. The composition of claim 1 wherein the pH buffer comprises an acid selected from the group consisting of formic acid, acetic acid, propanoic acid, butanoic acid, pentanoic acid, hexanoic acid, heptanoic acid, octanoic acid, nonanoic acid, decanoic acid, trichloroacetic acid, hydrofluoric acid, hydrocyanic acid, phosphoric acid, oxalic acid, nitrous acid, benzoic acid, ascorbic acid, boric acid, chromic acid, citric acid, carbonic acid, lactic acid, sulfurous acid, uric acid.

8. The composition of claim 1 wherein the pH buffer comprises KH₂PO₄ and/or Na₂HPO₄.

9. The composition of claim 7 wherein the pH buffer comprises the conjugate base of one or more of the acids.

10. The composition of claim 1 wherein the internal olefin sulfonate has from 12 to 34 carbon atoms.

11. A method of recovering hydrocarbons from a formation comprising injecting a hydrocarbon recovery composition comprising one or more internal olefin sulfonates and a pH buffer.

12. The method of claim 11 wherein the temperature of the hydrocarbon recovery composition is greater than 140° C. at one or more times in the method.

13. The method of claim 11 wherein the temperature of the hydrocarbon recovery composition is greater than 200° C. at one or more times in the method.

14. The method of claim 11 wherein the temperature of the hydrocarbon recovery composition is greater than 250° C. at one or more times in the method.

15. The method of claim 11 wherein the temperature in the formation is greater than 140° C.

16. A method of generating foam in a thermal enhanced oil recovery process comprising injecting a hot fluid, one or more internal olefin sulfonates and a pH buffer into a hydrocarbon formation.

17. The method of claim 14 wherein the hot fluid comprises steam, nitrogen or one or more hydrocarbons.

18. The method of claim 17 wherein the hot fluid is a hydrocarbon that is produced from the same formation to which the thermal enhanced oil recovery process is applied.
